(19) United States
(12) Patent Application Publication
(10) Pub. No.: US 2025/0013048 A1
(43) Pub. Date: Jan. 9, 2025

(54) OPTICAL WAVEGUIDE AND ENCAPSULATION METHOD THEREOF

(71) Applicant: BOE TECHNOLOGY GROUP CO., LTD., Beijing (CN)

(72) Inventors: Kang Guo, Beijing (CN); Xiao Zhang, Beijing (CN); Mengya Song, Beijing (CN); Duohui Li, Beijing (CN); Xin Gu, Beijing (CN)

(73) Assignee: BOE TECHNOLOGY GROUP CO., LTD., Beijing (CN)

(21) Appl. No.: 18/710,038

(22) PCT Filed: May 5, 2023
(86) PCT No.: PCT/CN2023/092161

§ 371 Date: May 14, 2024

(30) Foreign Application Priority Data
Jun. 17, 2022 (CN) 202210692256.8

(51) Int. Cl. G02B 27/01; G02B 6/34

(52) U.S. Cl. CPC G02B 27/0172; G02B 6/34

(57) ABSTRACT

An optical waveguide of the present disclosure has a first region and a second region, and the optical waveguide includes a waveguide dielectric layer, a grating layer and an encapsulation film layer laminated one on another. The grating layer includes a first grating and a second grating, the first grating is located in the first region, and the second grating is located in the second region. The waveguide dielectric layer is configured to transmit light rays coupled into the waveguide dielectric layer by the first grating to the second grating, to enable the light rays to be coupled out through the second grating. The encapsulation film layer covers a side of the first grating and the second grating away from the waveguide dielectric layer, and grooves of the first grating and the second grating are not filled with a material of the encapsulation film layer.

### TECHNICAL FIELD

The present disclosure belongs to the field of optical elements technology, in particular to an optical waveguide and an encapsulation method.

### BACKGROUND

Usually, a waveguide near-to-eye display system based on optical waveguide technology is composed of a micro-display, a quasi-collimating eyepiece set, waveguide medium, input coupling grating and output coupling grating, the coupling-in and coupling-out gratings are placed on the same transparent waveguide medium. The basic principle of the system is that the micro-display outputs the required virtual image information, and the eyepiece set functions to collimate the image information, and converts light rays at various field angles into parallel light rays. A propagation direction of the light rays is changed via the input coupling grating of the waveguide and enter the waveguide. The parallel light rays at various field angles meet the condition of total internal reflection in the waveguide medium and propagate laterally along the waveguide medium to reach the output coupling grating. The output coupling grating also changes the propagation direction of the light rays, and the light rays no longer meet the condition of total internal reflection in the waveguide, and exit from the waveguide, where light beams expand along the propagation direction, and are coupled out of the waveguide substrate and enter an observer's eyes, so as to achieve the pupil expansion. In order to propose better augmented reality (AR) eyewear to the consumer market, one important direction is the need to make a waveguide lighter and thinner.

Currently, the encapsulation of waveguide structure layers based on diffractive optical waveguides is mainly by adding a layer of cover glass, which has the problem of large thickness and weight of the overall waveguide.

### SUMMARY

An objective of the present disclosure is to solve at least one of the technical problems existing in the prior art, and to provide an optical waveguide and an encapsulation method.

In a first aspect, embodiments of the present disclosure provide an optical waveguide having a first region and a second region. The optical waveguide includes a waveguide dielectric layer, a grating layer and an encapsulation film layer laminated one on another. The grating layer includes a first grating and a second grating, the first grating is located in the first region, and the second grating is located in the second region. The waveguide dielectric layer is configured to transmit light rays coupled into the waveguide dielectric layer by the first grating to the second grating, to enable the light rays to be coupled out through the second grating. The encapsulation film layer covers a side of the first grating and the second grating away from the waveguide dielectric layer, and grooves of the first grating and the second grating are not filled with a material of the encapsulation film layer.

The optical waveguide further has a third region; the grating layer further includes a third grating located in the third region. The third grating is configured to change a transmission direction of the light rays which are coupled into the waveguide dielectric layer by the first grating and transmitted via the waveguide dielectric layer, and to transmit the light rays with the changed transmission direction to the second grating through the waveguide dielectric layer, to enable the light rays to be coupled out by the second grating. The encapsulation film layer covers a side of the third grating away from the waveguide dielectric layer, and grooves of the third grating are not filled with the material of the encapsulation film layer.

An included angle between a grating strip of the third grating and the waveguide dielectric layer is not equal to 90°.

The encapsulation film layer has a same refractive index as the waveguide dielectric layer.

The grating layer is made of a glass material or an imprinting adhesive having a refractive index of 1.7 to 2.1.

The waveguide dielectric layer is made of an inorganic dielectric material having a refractive index of 1.7 to 2.1.

The material of the encapsulation film layer is an inorganic dielectric material having a refractive index of 1.7 to 2.1.

The material of the encapsulation film layer is silicon nitride or silicon oxynitride.

A side of the encapsulation film layer away from the waveguide dielectric layer is covered with a protective film layer.

An included angle between each of grating strips of the first grating and the second grating and the waveguide dielectric layer is not equal to 90°.

In a second aspect, embodiments of the present disclosure provide an encapsulation method of an optical waveguide, the optical waveguide has a first region and a second region, and the method includes: forming a waveguide dielectric layer, a grating layer and an encapsulation film layer laminated one on another. Forming the grating layer includes: forming a first grating located in the first region and a second grating located in the second region on the waveguide dielectric layer, where the waveguide dielectric layer is configured to transmit light rays coupled into the waveguide dielectric layer by the first grating to the second grating, to enable the light rays to be coupled out through the second grating. The encapsulation film layer covers a side of the first grating and the second grating away from the waveguide dielectric layer, and grooves of the first grating and the second grating are not filled with a material of the encapsulation film layer.

The optical waveguide further has a third region; and upon forming the first grating and the second grating on the waveguide dielectric layer, the method further includes: forming a third grating located in the third region; where the third grating is configured to change a transmission direction of the light rays which are coupled into the waveguide dielectric layer by the first grating and transmitted via the waveguide dielectric layer, and to transmit the light rays with the changed transmission direction to the second grating through the waveguide dielectric layer, to enable the light rays to be coupled out by the second grating. The encapsulation film layer covers a side of the third grating away from the waveguide dielectric layer, and grooves of the third grating are not filled with the material of the encapsulation film layer.

Forming the encapsulation film layer includes: forming the encapsulation film layer through plasma enhanced chemical vapor deposition.

The plasma enhanced chemical vapor deposition has a deposition power of 100 W to 1000 W, a deposition pressure of 200 Torr to 1500 Torr, and a deposition atmosphere of silicon tetrahydride and nitrous oxide.

In a third aspect, embodiments of the present disclosure provide an augmented reality device that includes any of the optical waveguide described above.

### BRIEF DESCRIPTION OF THE DRAWINGS

FIG. 1 is a schematic diagram of an optical waveguide encapsulated with a glass cover plate in the prior art.

FIG. 2 is a cross-sectional view of an optical waveguide encapsulated with an encapsulation film layer according to the embodiments of the present disclosure.

FIG. 3 is a schematic diagram of an optical waveguide having a first grating and a second grating according to the embodiments of the present disclosure.

FIG. 4 is a cross-sectional view of an optical waveguide with grating strips non-perpendicular to a waveguide dielectric layer according to the embodiments of the present disclosure.

FIG. 5 is a cross-sectional view of an optical waveguide with a protective layer according to the embodiments of the present disclosure.

FIG. 6 is a schematic diagram of an optical waveguide with a third grating according to the embodiments of the present disclosure.

FIG. 7 is a cross-sectional view of an optical waveguide encapsulated with a third grating according to the embodiments of the present disclosure.

FIG. 8 is a cross-sectional view of an optical waveguide with a third grating of which grating strips are not perpendicular to a waveguide dielectric layer according to the embodiments of the present disclosure.

FIG. 9 is a cross-sectional view of an optical waveguide with a third grating as well as a protective layer according to the embodiments of the present disclosure.

FIG. 10 is a schematic diagram of an integral encapsulation for a waveguide dielectric layer and a grating layer according to the embodiments of the present disclosure.

FIG. 11 is a schematic diagram of an integral encapsulation for a waveguide dielectric layer and a grating layer with a third grating according to the embodiments of the present disclosure.

### REFERENCE SIGN LIST

1 waveguide dielectric layer
2 first grating
3 second grating
4 third grating
5 encapsulation film layer
6 protective film layer

### DETAILED DESCRIPTION

In order that those skilled in the art may better understand the technical aspects of the present disclosure, a detailed description will be given below with reference to the accompanying drawings and specific embodiments.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “include” or “including” intends to indicate that an element or object before the word contains an element or object or equivalents thereof listed after the word, without excluding any other element or object. Such words as “connect/connected to” or “couple/coupled to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

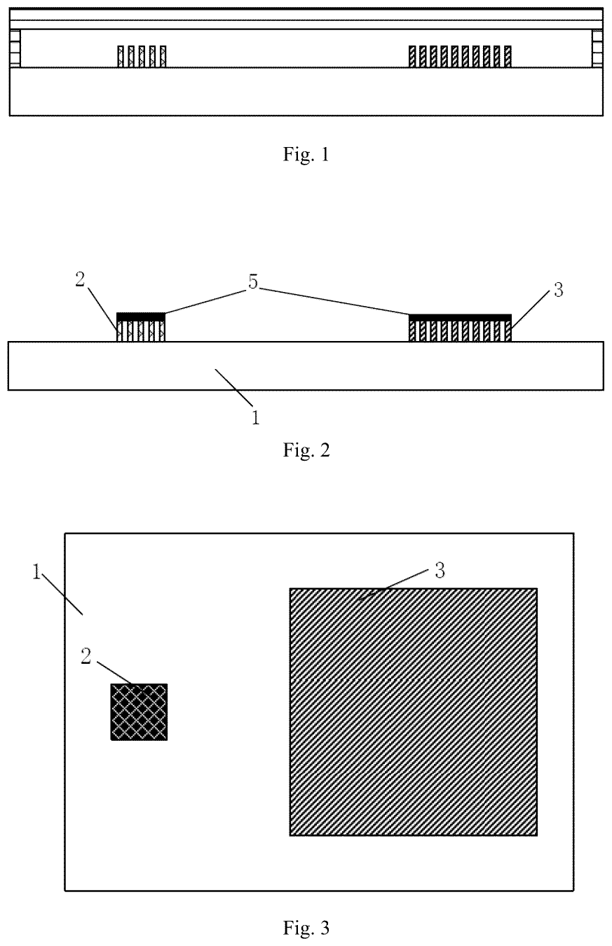

FIG. 1 is a schematic diagram of an optical waveguide encapsulated with a glass cover plate. As shown in FIG. 1, the optical waveguide includes a waveguide dielectric layer, a grating layer and a glass cover plate laminated one on another. The grating layer includes a coupling-in grating and a coupling-out grating, the coupling-in grating couples light rays into the waveguide dielectric layer, the coupled-in light rays experience total internal reflection in the waveguide dielectric layer and are transmitted to the coupling-out grating. The coupling-out grating couples the light rays in the waveguide dielectric layer out of the optical waveguide, and the light rays enter a human eye, so as to achieve the effect of augmented reality display. In the prior art, the optical waveguide is encapsulated with a glass cover plate, which makes a thickness and weight of the optical waveguide relatively large.

With the development of augmented reality display technology and near-to-eye display technology, augmented reality display devices are gradually put into the market, including augmented reality eyewear. Augmented reality eyewear includes a waveguide near-to-eye display system, which generally includes a micro-display and an optical waveguide to realize a near-to-eye display function. In the prior art, the optical waveguide is encapsulated with a glass cover plate in such a manner that the thickness and weight of the optical waveguide are large and the overall weight of the augmented reality eyewear is increased.

In view of this, the embodiments of the present disclosure provide an optical waveguide and an encapsulation method of the optical waveguide, where, during the encapsulation, an inorganic dielectric thin film is deposited on a grating surface and a waveguide dielectric layer surface. When an inorganic dielectric material, instead of the glass cover plate, is used to form the thin film, it is able to realize a light and thin optical waveguide, and reduce the weight of augmented reality eyewear.

Hereinafter, the optical waveguide according to the embodiments of the present disclosure will be described with reference to the accompanying drawings and specific embodiments.

In a first aspect, the embodiments of the present disclosure provide an optical waveguide including a waveguide dielectric layer 1, a grating layer and an encapsulation film layer 5 laminated one on another. The waveguide dielectric layer 1 at least includes two regions provided with gratings, the grating layer at least includes a first grating 2 and a second grating 3, the first grating 2 serves as a coupling-in grating and the second grating 3 serves as a coupling-out grating. The first grating 2 couples light rays emitted from a light source into the waveguide dielectric layer 1, and the coupled-in light rays experience continuous total internal reflection in the waveguide dielectric layer 1 until the light rays are transmitted to the second grating 3, and the light rays are coupled out of the waveguide dielectric layer 1 by the second grating 3.

Note that the light source may be a micro-display. The first grating 2 and the second grating 3 may be arranged on a same side or different sides according to the structure of the augmented reality eyewear. In the present application, an illustration is given by taking a case where the first grating 2 and the second grating 3 are arranged on the same side of the waveguide dielectric layer as an example.

In the embodiments of the present disclosure, the encapsulation film layer 5 at least covers a side of the first grating 2 and the second grating 3 away from the waveguide dielectric layer 1, and a part of the waveguide dielectric layer 1 which is not provided with a grating may also be covered by the encapsulation film layer 5. The material of the encapsulation film layer 5 does not fill into the grooves of each grating, so that the grating is encapsulated while not affecting the function of each grating. In addition, the glass cover plate is replaced by the inorganic dielectric thin film for encapsulation, it is able to reduce the thickness and weight of the optical waveguide.

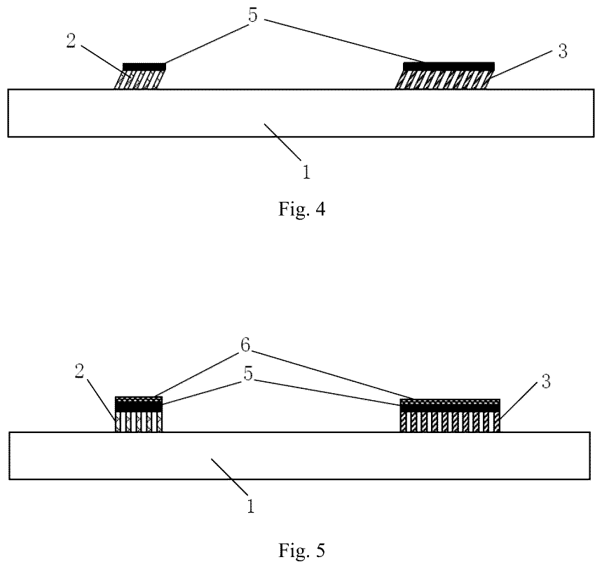

In a first example, FIG. 2 is a cross-sectional view of an optical waveguide encapsulated with an encapsulation film layer according to the embodiments of the present disclosure, FIG. 3 is a schematic diagram of an optical waveguide having a first grating and a second grating according to the embodiments of the present disclosure, FIG. 4 is a cross-sectional view of an optical waveguide with grating strips non-perpendicular to a waveguide dielectric layer according to the embodiments of the present disclosure, and FIG. 5 is a cross-sectional view of an optical waveguide with a protective layer according to the embodiments of the present disclosure. As shown in FIGS. 2, 3, 4 and 5, in the optical waveguide, the optical waveguide includes a first region and a second region, and the grating layer includes a first grating 2 and a second grating 3. The first grating 2 is arranged in the first region and the second grating 3 is arranged in the second region. The first grating 2 serves as a coupling-in grating and the second grating 3 serves as a coupling-out grating. Light rays are coupled into the waveguide dielectric layer 1 from the first grating 2, the coupled-in light rays from the first grating 2 undergo continuous total internal reflection in the waveguide dielectric layer 1 and finally propagate to the second grating 3, and light rays are coupled out of the waveguide dielectric layer 1 from the second grating 3.

Further, in the embodiments of the present disclosure, the light rays coupled into the waveguide dielectric layer 1 from the first grating 2 are coupled out from the second grating 3, and a transmission direction thereof does not change during the transmission thereof. Generally, an area of the second grating 3 is greater than that of the first grating 2, and the second region on the optical waveguide is also greater than the first region. The grooves of the first grating 2 and the second grating 3 extend in the same direction. In this way, one-dimensional pupil expansion is realized, and a visible range of interpupillary direction is extended.

It should be noted that the size and proportion of the covered area of the first grating 2 and the second grating 3 and the directions in which the grating grooves thereof extend are not further defined in the present disclosure, and the size and proportion of the area of the first grating 2 and the second grating 3 and the directions in which the grooves thereof extend may be adjusted according to the specific situation of the augmented reality eyewear.

In some examples, the refractive index of the encapsulation film layer 5 is the same as the waveguide dielectric layer 1, ensuring efficient propagation of the light rays on the optical waveguide. Since the refractive indexes of the encapsulation film layer 5 and the waveguide dielectric layer 1 are the same, when light rays enter the first grating 2 from an image display device, the light rays are not deflected. In a case that the refractive indexes of the encapsulation film layer 5 and the waveguide dielectric layer 1 are not the same, when light rays are coupled into the grating, an angle may be deflected, thereby affecting the efficiency and effect of light rays coupling into the waveguide dielectric layer 1.

In some examples, a material of the grating layer is a glass material or an imprinting adhesive, and a refractive index of the material is between 1.7 and 2.1. It should be noted that in the present application, the specific structure and type of the glass material are not further defined, and the specific structure and type of the imprinting adhesive are not further defined.

In some examples, the material of the waveguide dielectric layer 1 is an inorganic dielectric material, and in order to achieve total internal reflection of light rays in the waveguide dielectric layer 1, a refractive index of the material needs to be 1.7 to 2.1. It should be noted that in the present application, the material of the waveguide dielectric layer 1 is not further defined, and may be the same glass material as the grating layer, or any other type of inorganic dielectric materials, both of which need to ensure that the refractive index of the material is between 1.7 and 2.1.

In some examples, the material of the encapsulation film layer 5 is an inorganic dielectric material having a refractive index of 1.7 to 2.1. Silicon nitride (SiN) or silicon oxynitride (SiON) is generally used as the inorganic dielectric material of the encapsulation film layer 5. The first grating 2 and the second grating 3 in the embodiments of the present disclosure each use a nanoscale grating with a grating period of 250 nanometers (nm) to 450 nanometers (nm) and a groove width of 125 nanometers (nm) to 225 nanometers (nm). In the deposition process, plasma-enhanced chemical vapor deposition (PECVD) is used, where the deposition power is controlled from 100 W to 1000 W, the deposition pressure is controlled from 200 Torr to 1500 Torr, and silicon tetrahydride and nitrous oxide are used as the deposition atmosphere. With the above-mentioned deposition method and deposition conditions, the filling ratio of the thin film of the inorganic dielectric material in the grooves of the nanoscale grating may be controlled so that the inorganic dielectric material does not fill in the grating grooves. Therefore, when an inorganic dielectric material such as silicon nitride (SiN) or silicon oxynitride (SiON) is used in combination with the deposition method and deposition conditions, the inorganic dielectric material of the encapsulation film layer does not enter into the grating grooves, and thereby the coupling of the light rays is not affected.

In some examples, the grating strips of the first grating 2 and the second grating 3 are no longer arranged perpendicularly on the waveguide dielectric layer 1, but form an included angle, in order that the grooves of the gratings are not filled by the inorganic dielectric material of the encapsulation film layer. In the encapsulation process of the inorganic dielectric material of the encapsulation film layer 5, since the grating strips of the first grating 2 and the second grating 3 form a certain included angle with the waveguide dielectric layer 1, and side faces of the grating strips form a certain slope, an inevitable fine material residue in the encapsulation process may not easily enter the depth of the grating groove, and thereby the coupling effect of the first grating 2 and the second grating 3 is not affected. It should be noted that inclination angles of the grating strips of the first grating 2 and the second grating 3 in the present application are not further defined.

In some examples, the optical waveguide is mainly used in the augmented reality eyewear, and in order to increase the service life of the augmented reality eyewear and improve the product quality, a protective film layer 6 is coated on the encapsulation film layer 5 of the optical waveguide, so as to play the role of wear resistance and contamination resistance. Note that the material of the protective film layer 6 is not particularly defined in the present disclosure.

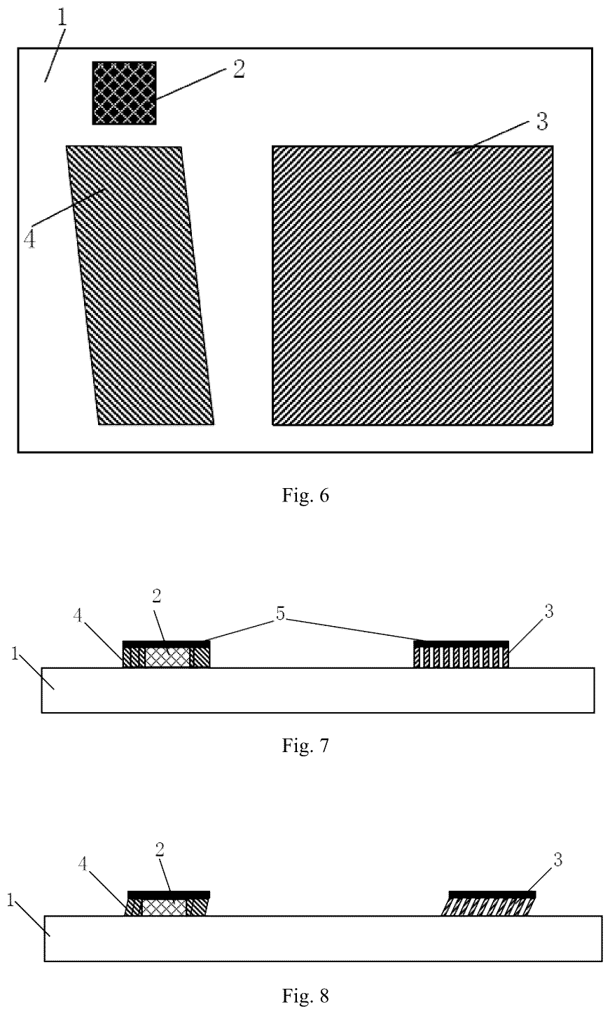

In a second example, FIG. 6 is a schematic view of an optical waveguide with a third grating according to the embodiments of the present disclosure, FIG. 7 is a cross-sectional view of an optical waveguide encapsulated with a third grating according to the embodiments of the present disclosure, FIG. 8 is a cross-sectional view of an optical waveguide with a third grating of which grating strips are not perpendicular to a waveguide dielectric layer according to the embodiments of the present disclosure, FIG. 9 is a cross-sectional view of an optical waveguide with a third grating as well as a protective layer according to the embodiments of the present disclosure. As shown in FIGS. 6, 7, 8 and 9, in the optical waveguide, the optical waveguide includes a first region and a second region, and further includes a third region, and the grating layer includes a first grating 2 and a second grating 3, and further includes a third grating 4. The first grating 2 is arranged in the first region, the second grating 3 is arranged in the second region and the third grating 4 is arranged in the third region. The first grating 2 is used as a coupling-in grating, the second grating 3 is used as a coupling-out grating, and the third grating 4 is used as a turning grating. Light rays are coupled into the waveguide dielectric layer 1 from the first grating 2, and the light rays coupled in from the first grating 2 perform continuous total internal reflection in the waveguide dielectric layer 1 and propagate to the third grating 4. The third grating 4 changes the original propagation direction of the light rays propagating from the waveguide dielectric layer 1, and the light rays with the changed propagation direction propagates to the second grating 4; and are coupled out of the waveguide dielectric layer 1 from the second grating 4.

It should be noted that, unlike the optical waveguide only having the first grating 2 and the second grating 3, in the embodiments of the present disclosure, the transmission direction of light rays coupled into the waveguide dielectric layer 1 from the first grating 2 and coupled out at the second grating 3 changes during the transmission process. Generally, the area of the second grating 3 is greater than that of the first grating 2, and the second region on the optical waveguide is also greater than the first region. In order to enable the third grating 4 to change the propagation direction of light rays in the waveguide dielectric layer 1, a groove extension direction of the third grating 4 forms a certain included angle with both a groove extension direction of the first grating 2 and a groove extension direction of the second grating 3, and the groove extension direction of the first grating 2 also need to have a certain included angle with the groove extension direction of the second grating 3.

Furthermore, in the example of the present disclosure, a case where the groove extension direction of the first grating 2 form an included angle of 90° with the groove extension direction of the second grating 3, and the groove extension direction of the third grating 4 forms an included angle of 45° with the groove extension direction of the first grating 2 and the groove extension direction of the second grating 3 is taken as an example for illustration. The light rays are coupled into the waveguide dielectric layer 1 from the first grating 2, and the coupled-in light rays undergo continuous total internal reflection in the waveguide dielectric layer, and propagate to the third grating 4. The third grating 4 deflects the propagating light rays by an included angle of 90°, that is to say, changing the direction of the light rays from the x-axis direction to the y-axis direction. Next, the changed light rays propagates to the second grating 3; and are coupled out of the waveguide dielectric layer 1 through the second grating 3. Therefore, a two-dimensional pupil expansion in the x-axis direction and the y-axis direction is achieved. When it is applied to the augmented reality eyewear, the visual range of interpupillary direction and nasal bridge direction is extended.

It should be noted that the size and proportion of the covered area of the first grating 2, the second grating 3 and the third grating 4 and the directions in which the grating grooves thereof extend are not further defined in the present disclosure, and the area and proportion of the first grating 2, the second grating 3 and the third grating 4 and the directions in which the grooves thereof extend may be adjusted according to the specific situation of the augmented reality eyewear.

In some examples, plasma enhanced chemical vapor deposition (PECVD) is used during the deposition process, where the deposition power is controlled from 100 W to 1000 W, the deposition pressure is controlled from 200 Torr to 1500 Torr, and silicon tetrahydride and nitrous oxide are used as the deposition atmosphere. The third grating 4 in the embodiments of the present disclosure employs a nanoscale grating having a grating period of 250 nanometers (nm) to 450 nanometers (nm) and a groove width of 125 nanometers (nm) to 225 nanometers (nm). With the above-mentioned deposition method and deposition conditions, the filling ratio of the thin film of the inorganic dielectric material in the grooves of the nanoscale grating may be controlled so that the inorganic dielectric material does not fill in the grating grooves. Therefore, when an inorganic dielectric material such as silicon nitride (SiN) or silicon oxynitride (SiON) is used in combination with the deposition method and deposition conditions, the inorganic dielectric material of the encapsulation film layer does not enter into the grating grooves, and thereby the coupling of the light rays is not affected rays.

In some examples, the grating strips of the third grating 4 are no longer arranged perpendicularly on the waveguide dielectric layer 1, but form an included angle, in order that the grooves of the grating are not filled by the inorganic dielectric material of the encapsulation film layer. In the encapsulation process of the inorganic dielectric material of the encapsulation film layer 5, since the grating strips of the third grating 4 form a certain included angle with the waveguide dielectric layer 1, and side faces of the grating strips form a certain slope, an inevitable fine material residue in the encapsulation process may not easily enter the depth of the grating groove, and thereby the coupling effect of the third grating 4 is not affected. It should be noted that an inclination angle of the grating strips of the third grating 4 in the present application is not further defined.

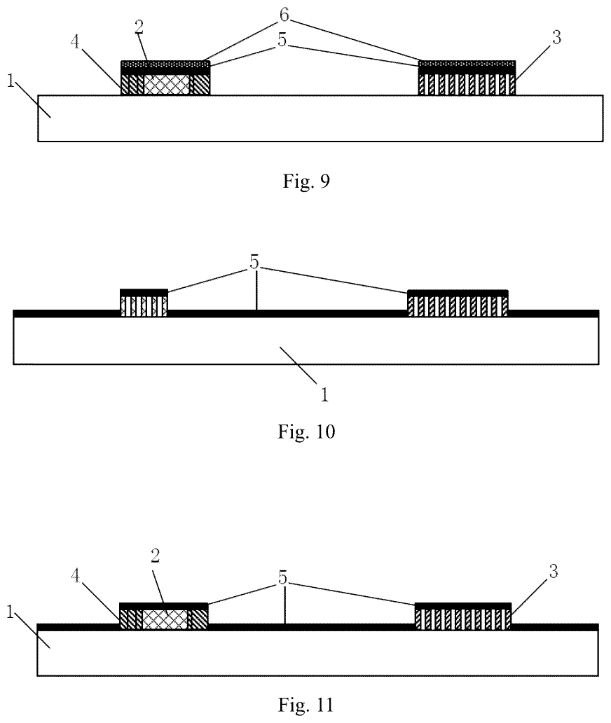

In some examples, FIG. 10 is a schematic diagram of an integral encapsulation for a waveguide dielectric layer and a grating layer according to the embodiments of the present disclosure, FIG. 11 is a schematic diagram of an integral encapsulation for a waveguide dielectric layer and a grating layer with a third grating according to the embodiments of the present disclosure. As shown in FIGS. 10 and 11, the encapsulation film layer 5 further covers a part of the waveguide dielectric layer 1 which does not include the grating layer, so that the covering may be more comprehensive during the encapsulation, and when one side of the waveguide dielectric layer 1 with the gratings is entirely encapsulated, it is able to provide a better encapsulation effect for the optical waveguide. Furthermore, on the encapsulation film layer 5 covering the waveguide dielectric layer 1 which does not include a grating layer, a protective film layer 6 may also be covered, so it is able to provide a more integral protection for one side of the waveguide dielectric layer 1 of the optical waveguide having the gratings.

It should be noted herein that since the inorganic dielectric material of the encapsulation film layer is very light and thin, when the encapsulation film layer 5 is also covered in a region of the waveguide dielectric layer 1 which does not include the grating layer, it does not cause a significant change in the weight of the optical waveguide, and may still be ensured that the optical waveguide is lighter and thinner than that encapsulated using a glass cover plate.

In a second aspect, the embodiments of the present disclosure provide an encapsulation method of an optical waveguide, the optical waveguide has a first region and a second region, and the method includes: forming a waveguide dielectric layer 1, a grating layer and an encapsulation film layer 5 laminated one on another. A first grating 2 located in a first region and a second grating 3 located in a second region are formed on the waveguide dielectric layer 1, thereby forming the grating layer. The waveguide dielectric layer 1 is configured to enable light rays coupled in by the first grating 2 to experience total internal reflection and to be transmitted to the second grating 3, so as to be coupled out by the second grating 3. The encapsulation film layer 5 is deposited on a side of the first grating 2 and the second grating 3 away from the waveguide dielectric layer 1, and grooves of the first grating 2 and the second grating 3 are not filled with an inorganic dielectric material of the encapsulation film layer.

In some examples, the optical waveguide further includes a third region, and a third grating 4 located in the third region is formed simultaneously with the first grating 2 and the second grating 3 formed on the waveguide dielectric layer. The third grating 4 is configured to change a transmission direction of the light rays which are coupled into the waveguide dielectric layer by the first grating 2 and transmitted via the waveguide dielectric layer 1, and to transmit the light rays with the changed transmission direction to the second grating 3 via the waveguide dielectric layer 1, so as to enable the light rays to be coupled out by the second grating 3. The encapsulation film layer 5 is deposited covering one side of the third grating 4 away from the waveguide dielectric layer 1, and no inorganic dielectric material of the encapsulation film layer fills in the grooves of the third grating 4.

In some examples, depositing the encapsulation film layer 5 is accomplished using plasma enhanced chemical vapor deposition (PECVD). The main advantages of Plasma enhanced chemical vapor deposition (PECVD) are low deposition temperature, minimal impact on the structures and physical properties of grating and waveguide dielectrics, good uniformity in thickness and composition of the formed encapsulation film layer 5, dense film structure with few pinholes and strong adhesion of the film layer.

Further, the plasma enhanced chemical vapor deposition has a deposition power of 100 W to 1000 W, a deposition pressure of 200 Torr to 1500 Torr, and a deposition atmosphere of silicon tetrahydride and nitrous oxide. With this deposition condition, the filling ratio of the thin film of the inorganic dielectric material in the grooves of the nano-scale grating may be controlled so that the inorganic dielectric material of the encapsulation film layer does not fill in the grating grooves.

In some examples, the optical waveguide includes a first region and a second region, the inorganic dielectric material of the encapsulation film layer is integrally deposited on one side of the waveguide dielectric layer having gratings by using a plasma enhanced chemical vapor deposition process, and the grating layer and the waveguide dielectric layer 1 are integrally covered. Next, the encapsulation film layer is patterned through a photolithography process to form a first pattern and a second pattern, where the first pattern and the second pattern respectively cover one side of the first grating 2 and the second grating 3 away from the waveguide dielectric layer 1, and remaining portions of the integrally deposited encapsulation film layer except for the first pattern and the second pattern are removed through an etching process, leaving the encapsulation film layer covering the first grating 2 and the second grating 3.

In some examples, the optical waveguide further includes a third region, the inorganic dielectric material of the encapsulation film layer is integrally deposited on one side of the waveguide dielectric layer having the gratings by using a plasma enhanced chemical vapor deposition process, and the grating layer and the waveguide dielectric layer 1 are integrally covered. Next, the encapsulation film layer is patterned through a photolithography process, and in addition to forming the first pattern and the second pattern, a third pattern is also formed. The third pattern covers a side of the third grating 4 away from the waveguide dielectric layer. Remaining portions of the integrally deposited encapsulation film layer except for the first pattern, the second pattern and the third pattern are removed through an etching process, leaving the encapsulation film layer covering the first grating 2, the second grating 3 and the third grating 4.

In some examples, the encapsulation film layer 5 further covers the part of the waveguide dielectric layer 1 which does not include a grating layer, so that the covering may be more comprehensive during the encapsulation. Furthermore, when one side of the waveguide dielectric layer 1 with gratings is entirely encapsulated, it is able to provide a better encapsulation effect for the optical waveguide. In addition, on the encapsulation film layer 5 covering the waveguide dielectric layer 1 which does not include a grating layer, a protective film layer 6 may also be covered, so it is able to provide a more integral protection for one side of the waveguide dielectric layer 1 of the optical waveguide having the gratings. In the encapsulation process, the inorganic dielectric material of the encapsulation film layer is integrally deposited on one side of the waveguide dielectric having the gratings by using a plasma enhanced chemical vapor deposition process, and the grating layer and the waveguide dielectric layer 1 are integrally covered. Next, the encapsulation film layer is patterned through a photolithography process, so that each pattern is deposited at a corresponding position, without removing the encapsulation film layer 5 which is not covered on the grating layer through an etching process. Thus, while encapsulating the waveguide dielectric layer 1 more completely through the encapsulation film layer 5, the etching process is also reduced, the manufacturing cost is reduced and the manufacturing cycle is shortened.

In a third aspect, the embodiments of the present disclosure provide an augmented reality device that includes the optical waveguide encapsulated through the above-mentioned method, where the optical waveguide is encapsulated by using an encapsulation film layer made of an inorganic dielectric material instead of a glass cover plate. With this encapsulation, while reducing the weight of the augmented reality device, the thickness and weight of the optical waveguide are reduced, making it more portable for the user.

The optical waveguide in the embodiments of the present disclosure may be used in the augmented reality device, such as augmented reality eyewear, and may also be used for other products related to augmented reality display technology and near-to-eye display technology.

In the optical waveguide in the embodiments of the present disclosure, an encapsulation film layer formed of an inorganic dielectric material is used by replacing a glass cover plate, and each grating groove is not filled with the inorganic dielectric material of the encapsulation film layer, so it is able to effectively reduce the thickness and weight of the optical waveguide while ensuring the function of the optical waveguide. In the encapsulation method of the optical waveguide in the embodiments of the present disclosure, the optical waveguide may be reliably encapsulated by using an encapsulation film layer formed of an inorganic material, instead of encapsulating the optical waveguide with a glass cover plate. Furthermore, the weight of the product may be effectively reduced while ensuring the function of the augmented reality device.

As can be appreciated, the above-described embodiments are merely illustrative of the principles of the present disclosure, and that the present disclosure is not limited thereto. Any modifications or replacements that would easily occurred to a person skilled in the art, without departing from the spirit and essence of the present disclosure, should be encompassed in the scope of the present disclosure.

1. An optical waveguide having a first region and a second region; wherein the optical waveguide comprises a waveguide dielectric layer, a grating layer and an encapsulation film layer laminated one on another; wherein
the grating layer comprises a first grating and a second grating, the first grating is located in the first region, and the second grating is located in the second region;
the waveguide dielectric layer is configured to transmit light rays coupled into the waveguide dielectric layer by the first grating to the second grating, to enable the light rays to be coupled out through the second grating;
the encapsulation film layer covers a side of the first grating and the second grating away from the waveguide dielectric layer, and grooves of the first grating and the second grating are not filled with a material of the encapsulation film layer.

2. The optical waveguide according to claim 1, wherein the optical waveguide further has a third region; the grating layer further comprises a third grating located in the third region; wherein
the third grating is configured to change a transmission direction of the light rays which are coupled into the waveguide dielectric layer by the first grating and transmitted via the waveguide dielectric layer, and to transmit the light rays with the changed transmission direction to the second grating through the waveguide dielectric layer, to enable the light rays to be coupled out by the second grating;
the encapsulation film layer covers a side of the third grating away from the waveguide dielectric layer, and grooves of the third grating are not filled with the material of the encapsulation film layer.

3. The optical waveguide according to claim 2, wherein an included angle between a grating strip of the third grating and the waveguide dielectric layer is not equal to 90°.

4. The optical waveguide according to claim 1, wherein the encapsulation film layer has a same refractive index as the waveguide dielectric layer.

5. The optical waveguide according to claim 1, wherein the grating layer is made of a glass material or an imprinting adhesive having a refractive index of 1.7 to 2.1.

6. The optical waveguide according to claim 1, wherein the waveguide dielectric layer is made of an inorganic dielectric material having a refractive index of 1.7 to 2.1.

7. The optical waveguide according to claim 1, wherein the material of the encapsulation film layer is an inorganic dielectric material having a refractive index of 1.7 to 2.1.

8. The optical waveguide according to claim 1, wherein the material of the encapsulation film layer is silicon nitride or silicon oxynitride.

9. The optical waveguide according to claim 1, wherein a side of the encapsulation film layer away from the waveguide dielectric layer is covered with a protective film layer.

10. The optical waveguide according to claim 1, wherein an included angle between each of grating strips of the first grating and the second grating and the waveguide dielectric layer is not equal to 90°.

11. An encapsulation method of an optical waveguide, wherein the optical waveguide has a first region and a second region, and the method comprises:
forming a waveguide dielectric layer, a grating layer and an encapsulation film layer laminated one on another; forming the grating layer comprises:
forming a first grating located in the first region and a second grating located in the second region on the waveguide dielectric layer; wherein the waveguide dielectric layer is configured to transmit light rays coupled into the waveguide dielectric layer by the first grating to the second grating, to enable the light rays to be coupled out through the second grating;
the encapsulation film layer covers a side of the first grating and the second grating away from the waveguide dielectric layer, and grooves of the first grating and the second grating are not filled with a material of the encapsulation film layer.

12. The method according to claim 11, wherein the optical waveguide further has a third region; and upon forming the first grating and the second grating on the waveguide dielectric layer, the method further comprises: forming a third grating located in the third region; wherein the third grating is configured to change a transmission direction of the light rays which are coupled into the waveguide dielectric layer by the first grating and transmitted via the waveguide dielectric layer, and to transmit the light rays with the changed transmission direction to the second grating through the waveguide dielectric layer, to enable the light rays to be coupled out by the second grating; the encapsulation film layer covers a side of the third grating away from the waveguide dielectric layer, and grooves of the third grating are not filled with the material of the encapsulation film layer.

13. The method according to claim 11, wherein forming the encapsulation film layer comprises:
forming the encapsulation film layer through plasma enhanced chemical vapor deposition.

14. The method according to claim 11, wherein the plasma enhanced chemical vapor deposition has a deposition power of 100 W to 1000 W, a deposition pressure of 200 Torr to 1500 Torr, and a deposition atmosphere of silicon tetrahydride and nitrous oxide.

15. An augmented reality device comprising the optical waveguide according to claim 1.

16. The augmented reality device according to claim 15, wherein the optical waveguide further has a third region; the grating layer further comprises a third grating located in the third region; wherein
the third grating is configured to change a transmission direction of the light rays which are coupled into the waveguide dielectric layer by the first grating and transmitted via the waveguide dielectric layer, and to transmit the light rays with the changed transmission direction to the second grating through the waveguide dielectric layer, to enable the light rays to be coupled out by the second grating;
the encapsulation film layer covers a side of the third grating away from the waveguide dielectric layer, and grooves of the third grating are not filled with the material of the encapsulation film layer.

17. The augmented reality device according to claim 16, wherein an included angle between a grating strip of the third grating and the waveguide dielectric layer is not equal to 90°.

18. The augmented reality device according to claim 15, wherein the encapsulation film layer has a same refractive index as the waveguide dielectric layer.

19. The augmented reality device according to claim 15, wherein the grating layer is made of a glass material or an imprinting adhesive having a refractive index of 1.7 to 2.1.

20. The augmented reality device according to claim 15, wherein the waveguide dielectric layer is made of an inorganic dielectric material having a refractive index of 1.7 to 2.1.
